(19) United States
(12) Patent Application Publication
(10) Pub. No.: US 2002/0066644 A1
(43) Pub. Date: Jun. 6, 2002

(54) Restricted article access device

(76) Inventors: Angel F. Hierrezuelo, Elizabeth, NJ (US); Jose A. Lopes, Elizabeth, NJ (US); William K. Skidmore, Howell, NJ (US); B. Stephen Speckhart JR., Short Hills, NJ (US)

Correspondence Address: KENYON & KENYON, ONE BROADWAY, NEW YORK, NY, 10004, US

(21) Appl. No.: 09/728,272

(22) Filed: Dec. 1, 2000

Related U.S. Application Data
(60) Provisional application No. 60/227,321.

(51) Int. Cl. B65G 17/20

(52) U.S. Cl. 198/617; 198/678.1

(57) ABSTRACT

A locking apparatus configured to restrict access to articles on a conveyor, such as hooked members, by having a locking piece which, when mounted adjacent to a portion of the conveyor and moved to an extended position, the locking piece rests against the articles and conveyor, thereby preventing an operator from removing the articles from the conveyor. The movement of the locking piece can be automated by coupling each locking piece to an actuator which moves the locking piece to the extended position, and coupling each actuator to an air solenoid unit controlled by a computer system. A series of locking pieces used together selectively restrict access to articles suspended only from certain slots within a frame on the conveyor. The series of locking pieces creates an automated locking system for unattended access of garments on a conveyor by being used on a conveyor placed inside a locked area and by being used in conjunction with an operator interface, a computer system and a selectively locking panel exposing a frontal frame on the conveyor path when opened.

### FIELD OF THE INVENTION

The present invention relates to a device and method for providing users with restricted access of articles, such as garments supported on hangers, on a conveyor.

### BACKGROUND INFORMATION

In many industries, there is a need for secure unattended article access systems which utilize minimal space. For example, in casinos or hospitals, employees working late night hours may need to retrieve their uniforms at the start of their shift and drop them off at the end of their shift, and have the uniforms either stored until the start of the next of shift or removed and cleaned until the start of their next shift.

Conventional automated retrieval and storage systems do not secure articles to a conveyor. Such automated retrieval and storage systems utilize more space because they maintain security by permitting access to articles only once the articles have been removed from the conveyor or otherwise isolated from the rest of the conveyor.

Systems to secure articles to a conveyor have been known, but they require a re-configuration of the slots on a conveyor or mechanisms which attach to every slot on the conveyor. In addition, such systems to secure articles to a conveyor are configured more to support articles on a hanging conveyor and prevent the articles from dropping out of the slots, but do not utilize an automated device to effectively prevent operators from removing the articles from the slots.

### SUMMARY OF THE INVENTION

The present invention provides a locking apparatus for restricting access to articles on a conveyor, such as hooked members which can be hangers supporting garments thereon. The locking apparatus in the present invention may be made part of an unattended article access system by providing restricted access to articles on a conveyor without requiring locking mechanisms on all slots on a conveyor and without requiring extra space to separate or otherwise isolate articles from the rest of the conveyor as required in the prior automated retrieval and storage systems.

The locking apparatus includes a locking piece which, when mounted adjacent to a portion of the conveyor and moved to an extended position, prevents removal of articles from the conveyor. In the extended position, the locking piece rests against the articles and the conveyor, and an operator will be unable to pull the articles from the conveyor with the locking piece blocking the way.

In one embodiment, the locking piece prevents removal of articles by having a surface adapted to engage one or more articles with one slot on the conveyor. A series of such similarly configured locking pieces may be used together, for example, to selectively restrict access to articles only in certain slots within a frame on the conveyor.

In another embodiment, the locking piece prevents removal of articles by having a larger surface adapted to engage one or more articles with an entire frame made of, for example, five adjacent slots. Two of these locking pieces can be used together, for example, on either side of a U-shaped turn of the path of the conveyor to block access to the frames on either side of the frame at the front of the U-shaped turn, along with a series of locking pieces configured according to the one embodiment to selectively restrict access of certain slots in the frame at the front of the U-shaped turn.

The present invention can be transformed into an automated locking device by coupling each locking piece to an actuator which moves the locking piece to the extended position. The actuator may be, for example, a dual acting air cylinder with a piston inside which drives the motion of the locking piece. The motion of the piston can be activated and controlled by a central locking control system made up of an air solenoid unit and a computer system connected to the air solenoid unit. The air solenoid unit, having one or more valves, can be connected to the air cylinder via the valve. The computer system controls the automated locking device by opening the valve, thus permitting air from the air solenoid unit to fill the air cylinder and push the piston and locking piece to the extended position. The computer system can open an exhaust port on the valve and a release of air from the air cylinder will return the piston and locking piece to a retracted position away from the articles and conveyor. When the locking piece is in a retracted position, an operator can access the corresponding slot or slots and either remove a hooked member from the slot or insert a hooked member into the slot.

The air solenoid unit may have multiple valves, and be connected to multiple automated locking devices via each valve. The central locking control system may separately control the movement of each automated locking device by having the computer system separately controlling the opening of each valve on the air solenoid unit and either permitting an intake of air into each cylinder or permitting the release of air from each cylinder.

The present invention may be part of an automated locking system for unattended access of garments on a conveyor. In this system, the conveyor may be contained in a secure area such as a locked room, and only a portion of the conveyor may be accessed by an operator from the outside via a selectively locking panel or window. The portion of the conveyor accessible by the operator can be, for example, the frontal frame of a U-shaped turn in the conveyor path. The movement of the conveyor, the control of each of the locking pieces to restrict an operator's access to an assigned slot and the unlocking of the selectively locking panel may be controlled by the computer system as a function of the identification information entered by the operator at an operator interface outside of the secure area, such as a magnetic card reader on an outside wall of the locked room.

Unlike prior automated retrieval and storage systems, the locking apparatus can be used to create an unattended secure article access system that does not require the additional space necessary to separate or otherwise isolate a desired article from the conveyor. The locking apparatus can be used on existing conveyors and adapted for any shaped path that the conveyor may have. The locking apparatus can create an unattended secure article access system merely by using it on a conveyor placed inside a locked area and in conjunction with an operator interface, a computer system and a selectively locking panel exposing a frontal frame on the conveyor path when opened.

### BRIEF DESCRIPTION OF THE DRAWINGS

FIG. 1 illustrates a first embodiment of a device according to the present invention.

FIG. 2A illustrates the first embodiment of the device of FIG. 1 in an extended position.

FIG. 2B illustrates the first embodiment of the device of FIG. 1 in a retracted position.

FIG. 3 illustrates a first view of a second embodiment of a device according to the present invention.

FIG. 4 illustrates a first view of a third embodiment of a device according to the present invention.

FIG. 5 illustrates a second view of the third embodiment of the device of FIG. 4.

FIG. 6 illustrates a fourth embodiment of the device according to the present invention.

FIG. 7A illustrates a fifth embodiment of the device according to the present invention.

FIG. 7B illustrates a sixth embodiment of the device according to the present invention.

FIG. 8A illustrates a seventh embodiment of the device according to the present invention.

FIG. 8B illustrates an eighth embodiment of the device according to the present invention.

FIG. 9 illustrates a ninth embodiment of the device according to the present invention.

FIG. 10 illustrates a first view of a tenth embodiment of the device according to the present invention.

FIG. 11 illustrates a second view of a tenth embodiment of the device of FIG. 10.

### DETAILED DESCRIPTION OF THE DRAWINGS

The present invention provides a locking apparatus for restricting access to articles on a conveyor, such as hooked members supporting garments thereon. The locking apparatus in the present invention can be made part of an unattended article access system by providing restricted access to articles on a conveyor without requiring locking mechanisms on all slots on a conveyor and without requiring extra space to separate or otherwise isolate articles from the rest of the conveyor as required in the prior automated retrieval and storage systems.

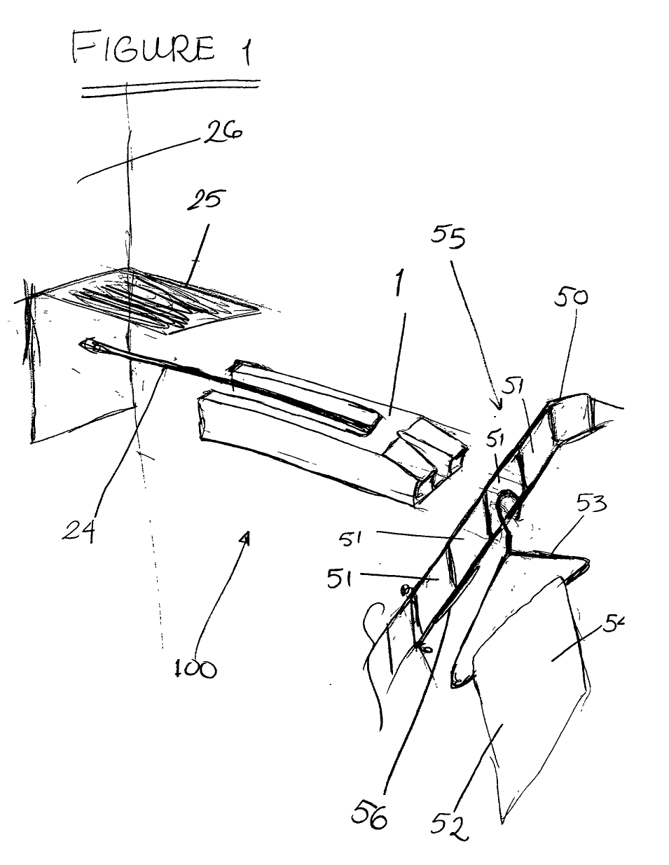

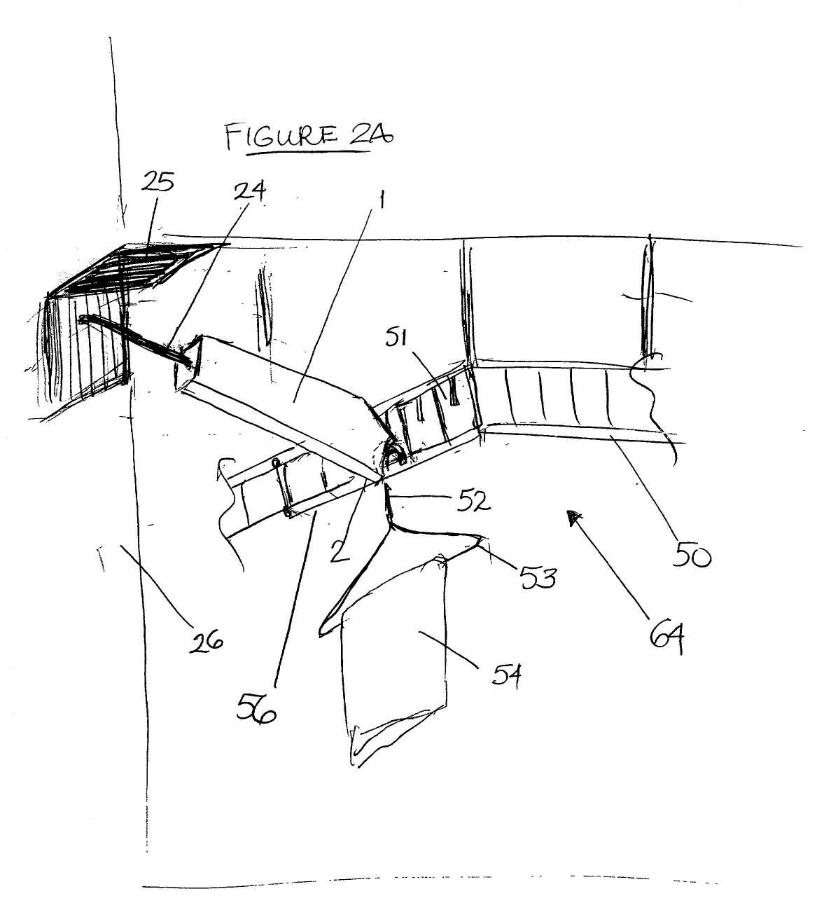

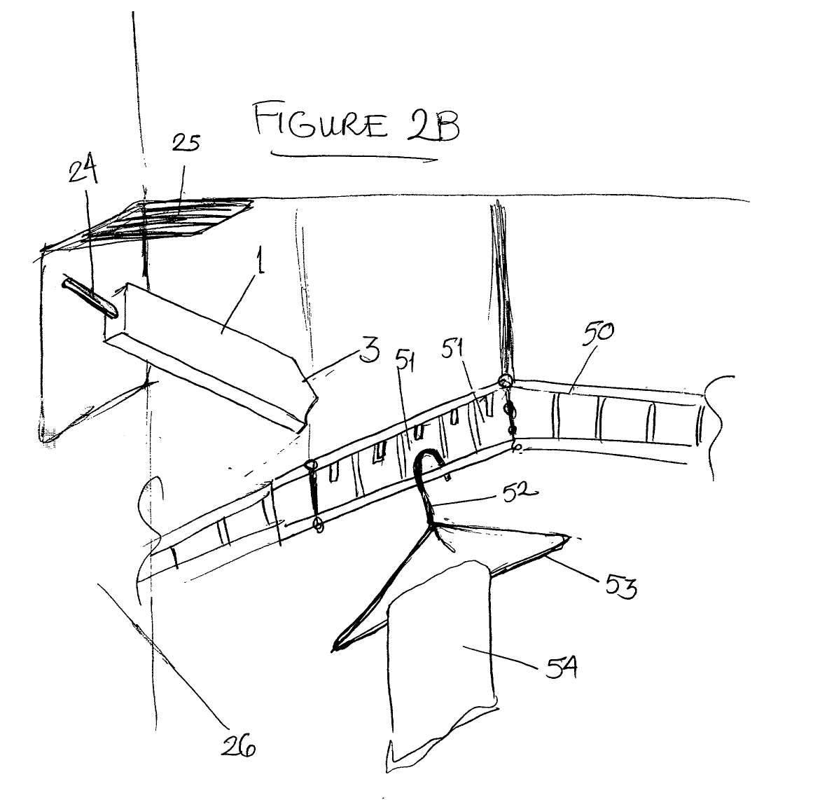

FIGS. 1, 2A-2B show an example device according to the present invention. As shown in FIG. 1, a locking piece 1 is part of a restricted article access system 100, along with a conveyor 50 for transporting articles 52, such as hooked members 53 suspending garments 54 thereon. The conveyor 50 for use with the current invention maybe configured to suspend and transport hooked members 53 from slots 51 on the conveyor 50. The conveyor 50 may be made up of a continuous chain of linked slots, or alternatively as shown, a continuous chain of linked frames 56 with each frame 56 containing a number of slots 51, for example five slots 51. The locking piece 1 may be moveably mounted, such as on a slidable rod 24, adjacent to a portion 55 of the conveyor 50. The slidable rod 24 may be mounted to a housing 25 which is mounted to a wall 26 or a fixed frame.

Movement of the locking piece 1 is shown in FIGS. 2A and 2B. When the locking piece 1 is moved to an extended position 2 against the article 52 and the conveyor 50, as shown in FIG. 2A, the locking piece 1 prevents an operator from being able to remove the article 52 from the conveyor 50. The locking piece 1 effectively blocks the path of removal which would be used by an operator standing on the outer periphery 64 of the conveyor 50. The locking piece 1 may optionally have a retracted position 3, as shown in FIG. 2B, when the locking piece 1 is moved away from the article 52 and the conveyor 50. When the locking piece 1 is in the retracted position 3, an operator is free to grab the article 52 and remove it from the slot 51.

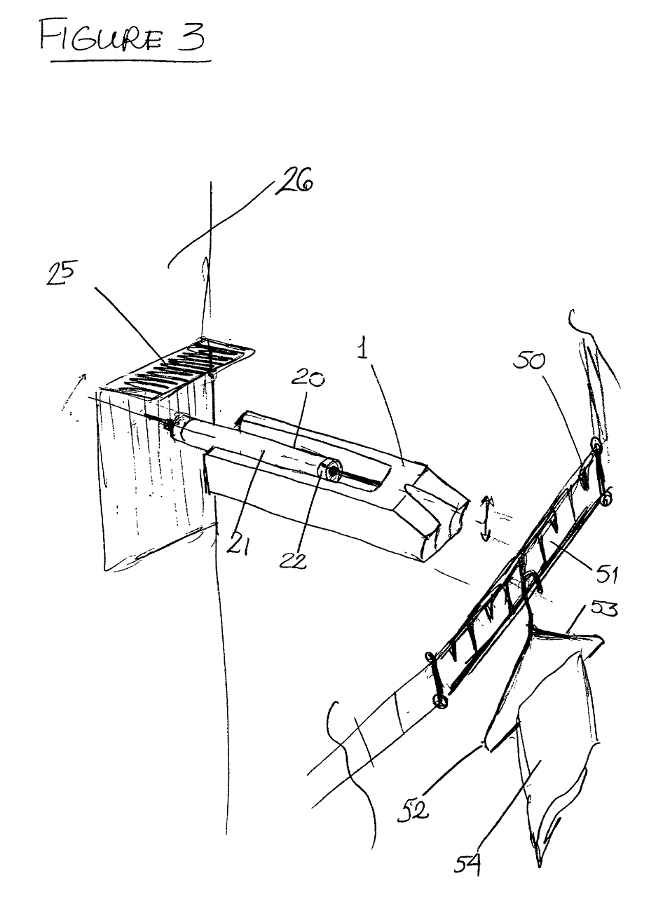

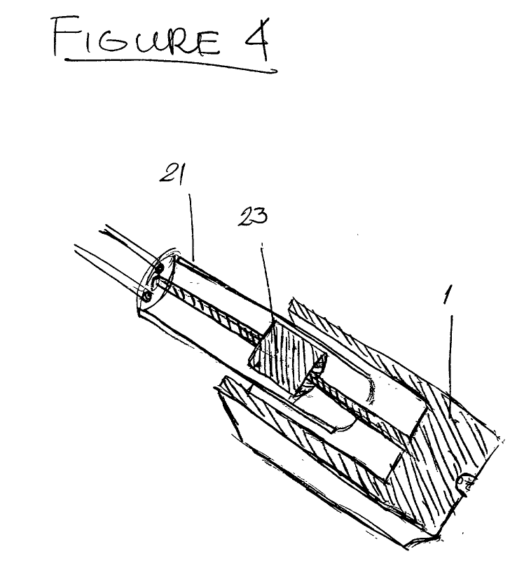

The movement of the locking piece 1 can be activated with a variety of motors. In a second embodiment of the device, shown in FIG. 3, the movement of the locking piece 1 may be driven by an actuator 20 coupled to the locking piece 1. As shown in FIG. 4, in a third embodiment, the actuator 20 may include a cylinder 21 such as a dual-acting air cylinder 22. A piston 23 can be movably mounted within the cylinder 21. A free end of the piston 23 can be coupled to the locking piece 1 and the movement of the piston 23 drives the movement of the locking piece 1.

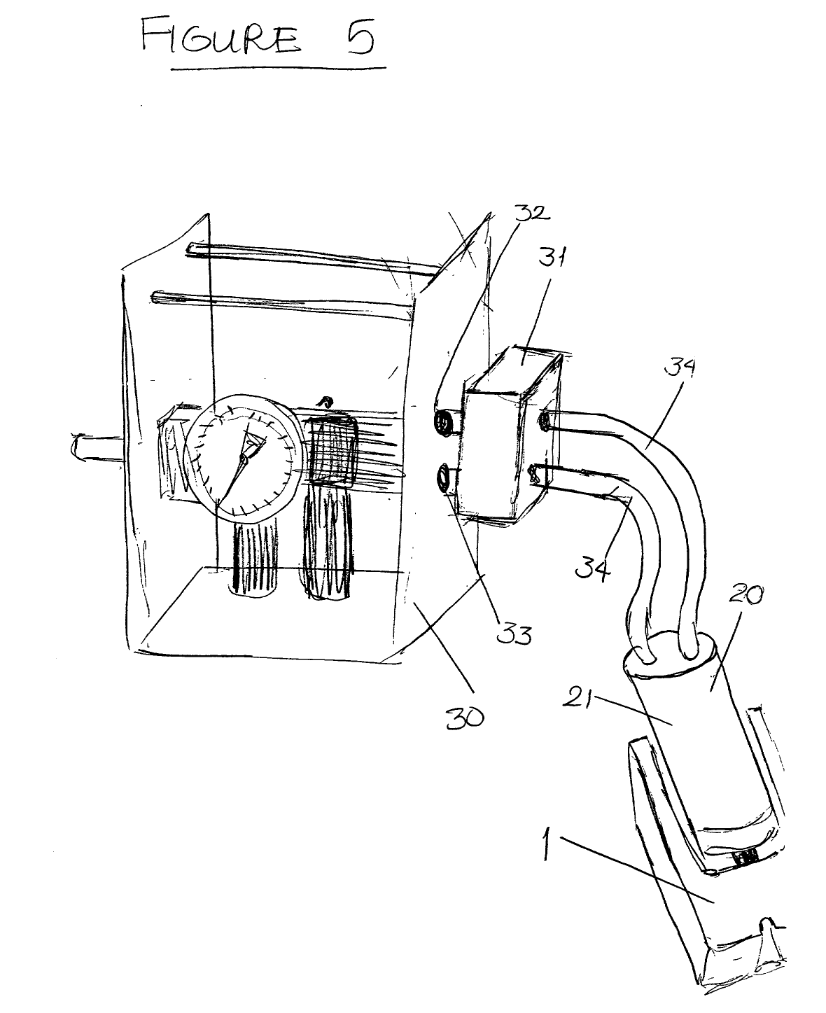

The cylinder 21 can be connected to and controlled by an air solenoid unit 30. In FIG. 5, an air solenoid unit 30 includes only one valve 31. The air solenoid unit 30 may include more than one valve 31, each valve 31 connected to a separate actuator 20 and locking piece 1. The valve 31 on the air solenoid unit 30 has an intake port 32 and an exhaust port 33. The cylinder 21 may be connected to the valve 31 using two hoses 34 anchored at the intake ports 32 and exhaust ports 33 of the valve 31.

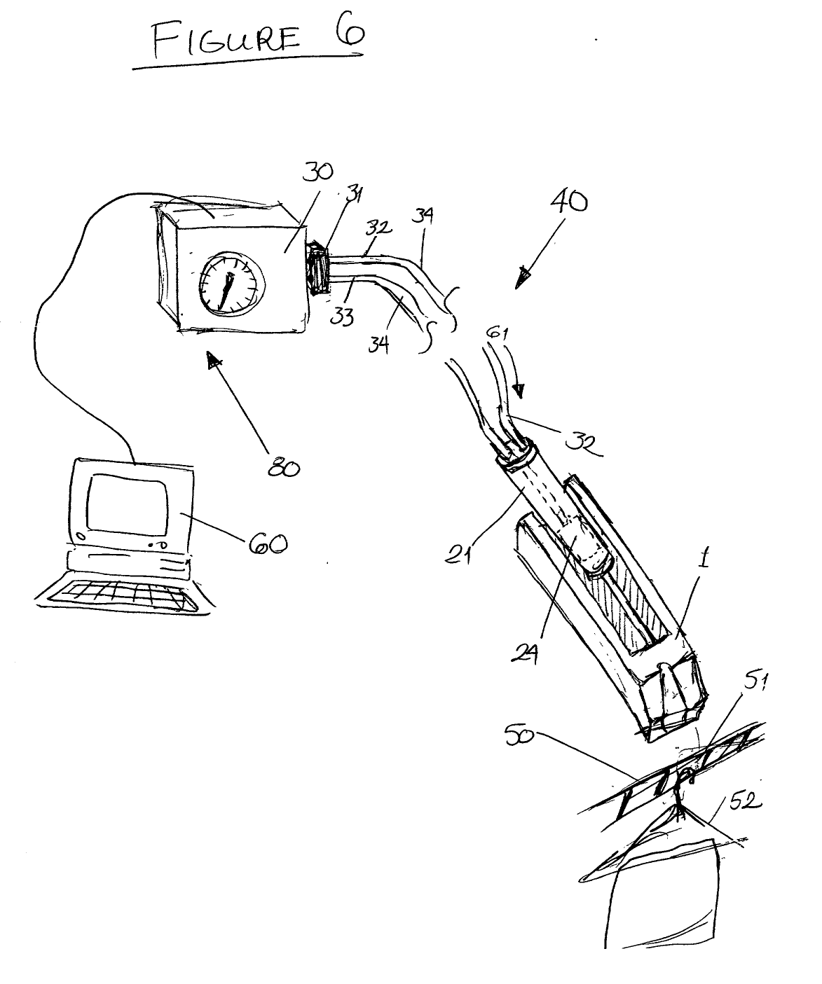

The present invention can be transformed into an automated locking device 40 in a fourth embodiment, by connecting the air solenoid unit 30 to a computer system 60, the air solenoid unit 30 and computer system 60 together forming a central locking control system 80 shown in FIG. 6. The computer system 60 may be configured to control the automated locking device 40 by controlling the opening of the intake port 32 and/or the exhaust port 33 on each valve 31 on the air solenoid unit 30. If the computer system 60 opens the intake port 32 on a valve 31 on the air solenoid unit 30, air flows in direction 61 from the air solenoid unit 30 (where a supply of air is maintained at a higher pressure) into the cylinder 21 and pushes the piston 23. The movement of the piston 23 moves the locking piece 1 forward to the extended position 2 against the articles 52 and the conveyor 50. If the computer system 60 opens the exhaust port 33 on a valve 31 on the air solenoid unit 30, air is released from the cylinder 21 and the piston 23 returns to its original position. The movement of the piston 23 returns the locking piece 1 to the retracted position 3. The computer system 60 may be configured to keep both the intake port 32 and exhaust port 33 closed in order to maintain the position of the locking piece 1 relative to the conveyor 50.

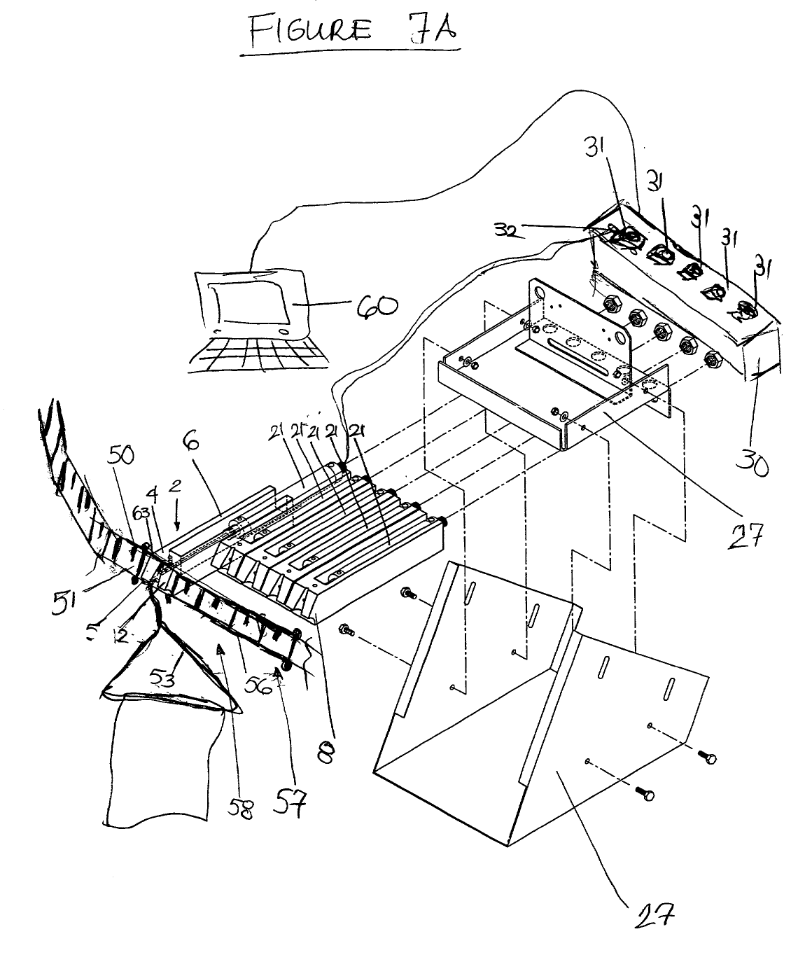

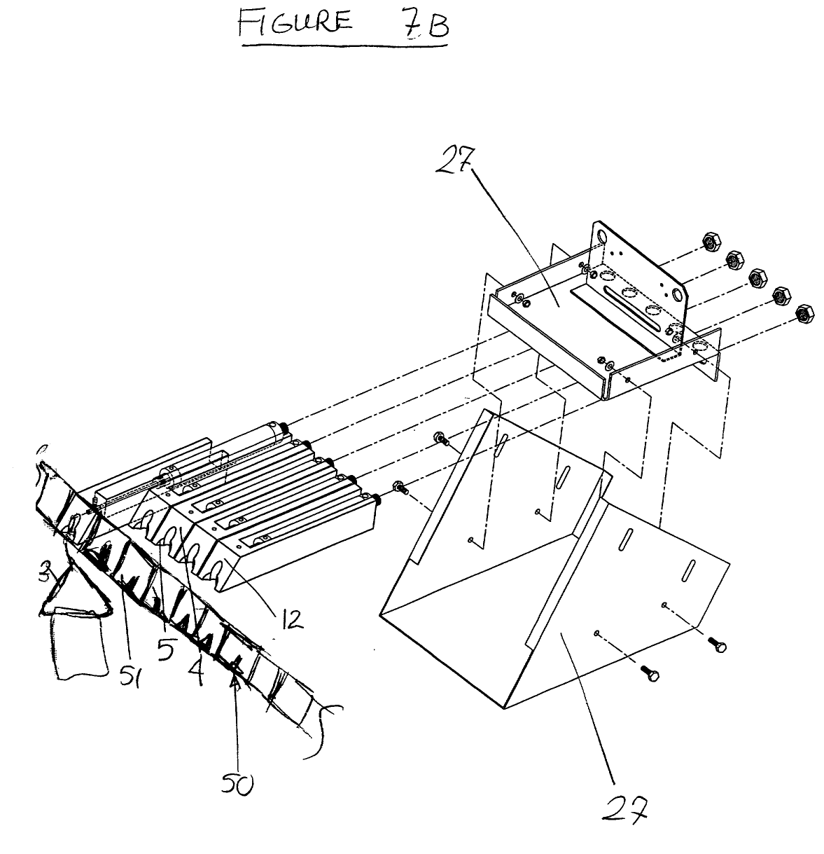

The shape and size of the locking piece 1 may vary according to the number of slots 51 that the locking piece 1 is configured to control. In a fifth embodiment shown in FIG. 7A, a slot-sized locking piece 4 prevents removal of articles 52 by having a surface 12 adapted to engage one or more articles 52 with one slot 51 on the conveyor 50. The profile 5 of the slot-sized locking piece 4 can be adapted to the shape of the slot 51 and how hooked members 53 are suspended from the slots 51 on a conveyor 50 as shown in a sixth embodiment in FIG. 7B.

A series 8 with a multitude of slot-sized locking pieces 4, for example five slot-sized locking pieces, may be used together, as shown in FIGS. 7A and 7B, to selectively restrict access to articles 52 only in certain slots 51 within a frame 56 of five slots 51 on the conveyor 50. Each locking piece 4 maybe connected to a cylinder 21 and one of the valves 31 on the air solenoid unit 30, and the movement of each locking piece 4 may be separately controlled by the computer system 60. All of the locking pieces 4 and cylinders 21 can be mounted in a casing 27 and mounted adjacent to a frame location 57 along the conveyor path 58. If the computer system 60 opens the intake port 32 on the valve 31 corresponding to the first locking piece 6 in the series 8, only the first locking piece 6 will be driven to an extended position 2, and an operator will only be blocked access to the first slot 63 in the frame 56. Alternatively, the computer system 60 may open the intake ports 32 on a number of the valves 31 driving a corresponding number of locking pieces 4 in the series 8 to the extended position 2. This permits an operator to access only the one slot 51 corresponding to the one retracted locking piece 4 in the series 8.

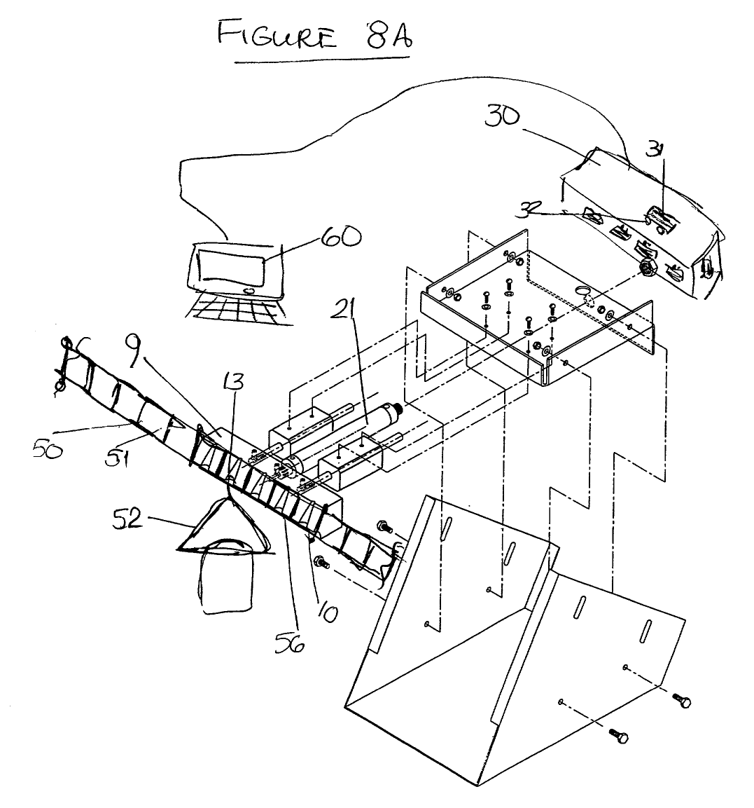

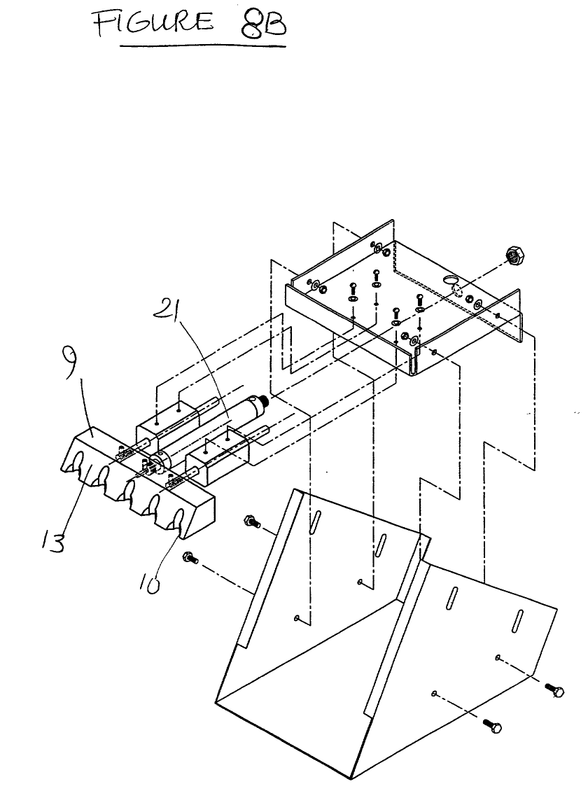

In a seventh embodiment shown in FIG. 8A, a frame-sized locking piece 9 prevents removal of articles 52 using a larger surface 13 adapted to engage one or more articles 52 with an entire frame 56 made of a multitude of adjacent slots, for example, five adjacent slots 51. If the computer system 60 opens the intake port 32 on the valve 31 corresponding to such a locking piece 9, the locking piece 9 is driven to an extended position 2 and blocks access to all of the slots 51 in the frame 56. Similar to the sixth embodiment, in an eighth embodiment shown in FIG. 8B, the profile 10 of the frame-sized locking piece 9 can be adapted to the shape of the slot 51 and manner in which hooked members 53 are suspended from the slots 51 on a conveyor 50.

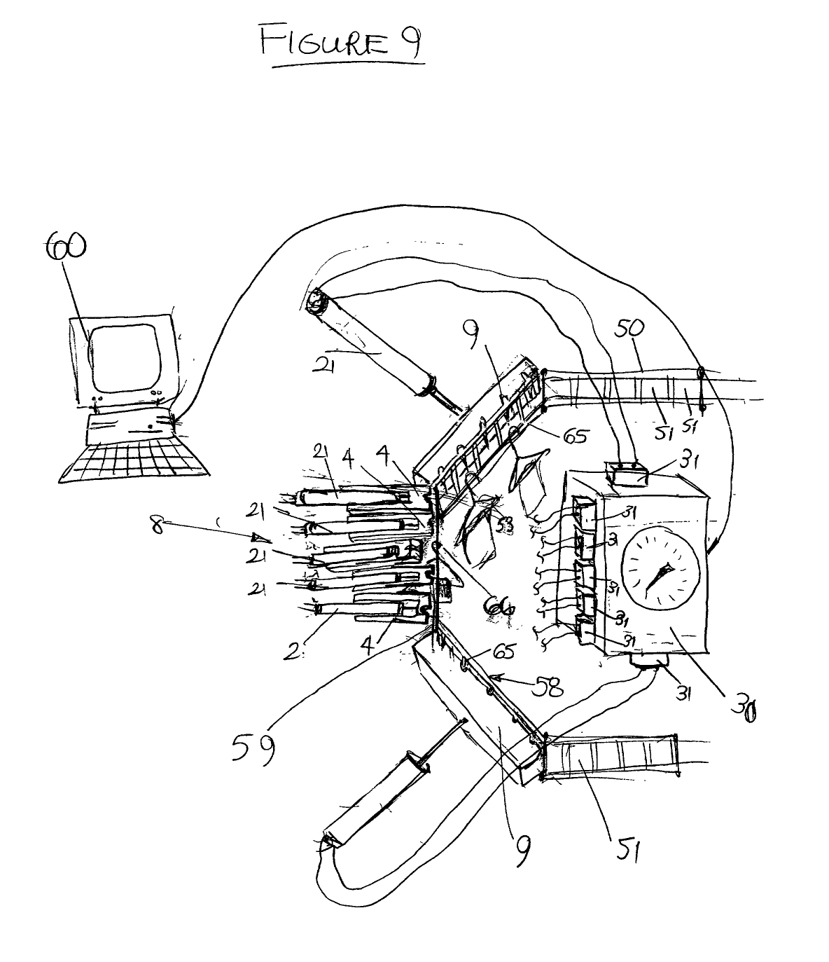

In a ninth embodiment shown in FIG. 9, two frame-sized locking pieces 9 can be used together, for example, on either side of a U-shaped turn 59 of the path 58 of the conveyor 50 to block access to the side frames 65 on either side of the frontal frame 66 on the U-shaped turn 59. A series 8 of slot-sized locking pieces 4 may be used to selectively restrict access of certain slots 51 in the frontal frame 66 on the U-shaped turn 59. Each of the locking pieces 4 and 9, and each of the cylinders 21 can be connected to one of seven valves 31 on the air solenoid unit 30, and each valve 31 may be separately controlled by the computer system 60. The computer system 60 may also be configured for starting the conveyor 50, moving the conveyor 50, and stopping the conveyor 50 when a frame has reached the side frame 65 or the frontal frame 66.

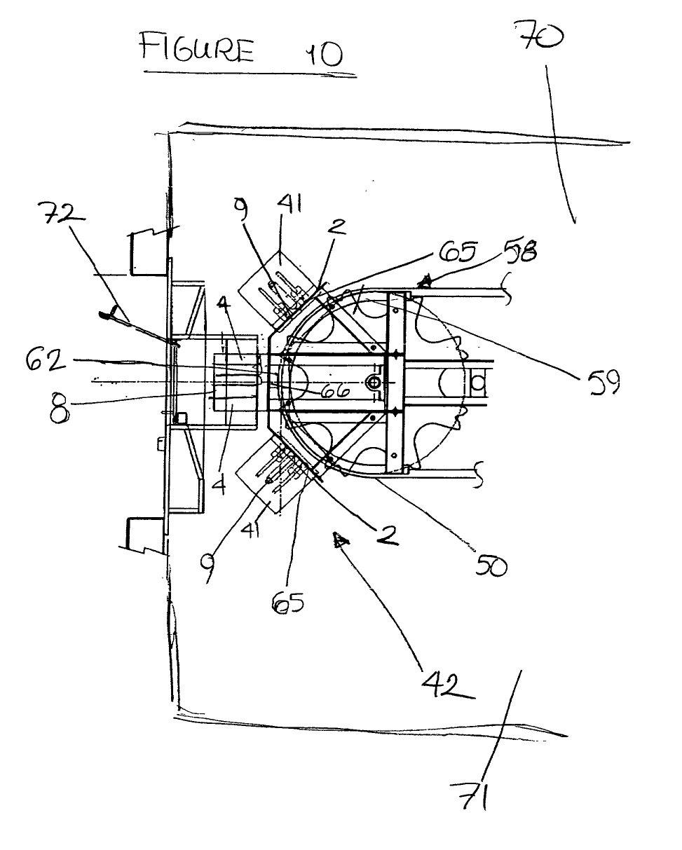

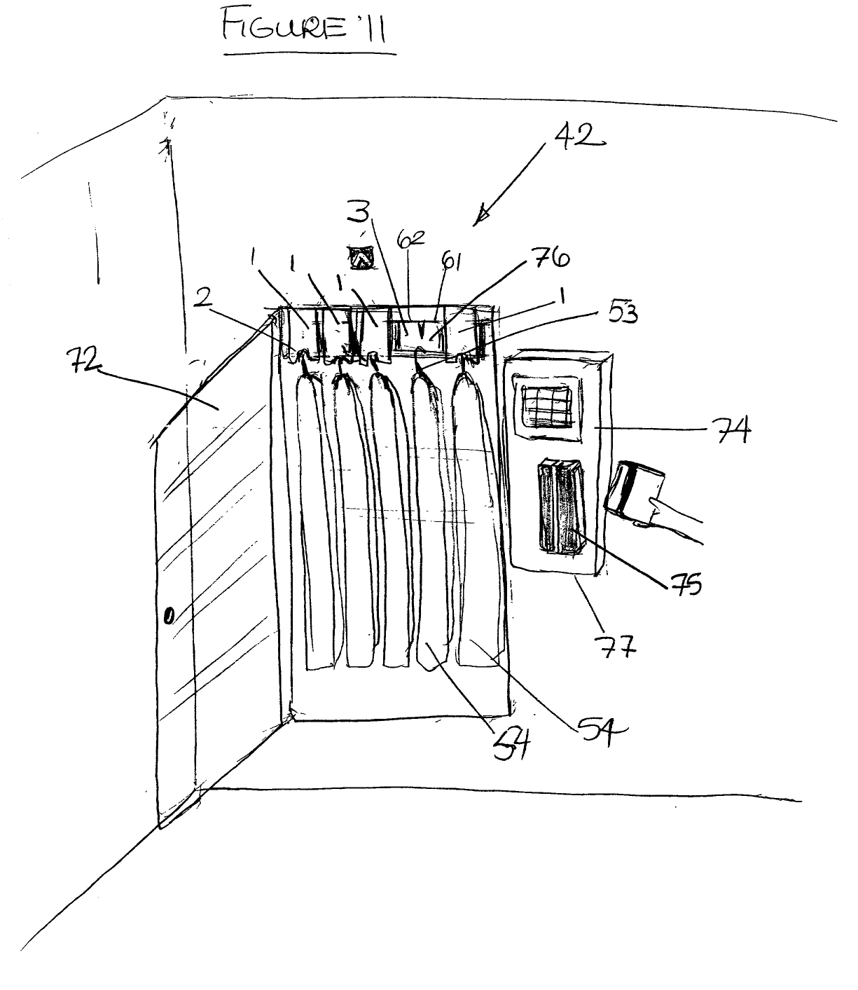

The present invention can be part of an automated locking system 42 for unattended access of garments 54 on a conveyor 50 in a tenth embodiment shown in FIGS. 10 and 11. In this system, the conveyor 50 is contained in a secure area 70 such as a locked room 71, and only a portion 62 of the conveyor 50 can be accessed by an operator from the outside via a selectively locking panel 72 or window at an article access station 73. The portion 62 of the conveyor 50 accessible by the operator may be, for example, the frontal frame 66 of a U-shaped turn 59 in the conveyor path 58. The movement of the conveyor 50, the control of each of the locking pieces 1 to restrict an operator's access to an assigned slot 76 and the unlocking of the selectively locking panel 72 may all be controlled by the computer system 60 as a function of the identification information entered by the operator at an operator interface 74 outside of the secure area 70, such as a magnetic card reader 75 on an outside wall 77 of the locked room 71.

In such an automated locking system 42, slots 51 on the conveyor 50 may be either pre-assigned to an individual operator or assigned when the operator drops the garments 54 off on the conveyor 50. The correlation between an assigned slot 76 and the individual may be stored in a database in the computer system 60. After the operator enters identification information, such as employee identification information, into the computer system 60 and before unlocking the panel 72, the computer system 60 may determine an original location of the assigned 76, move the conveyor 50 to until the assigned slot 76 is in the frontal frame 66 of the U-shaped turn 59 of the conveyor path 58, and move all of the slot-sized locking pieces 4 in the frontal frame 66 to an extended position 2 except for the slot-sized locking piece 4 corresponding to the assigned slot 76 which remains in a retracted position 3. The computer system 60 can thus restrict the operator's access to the assigned slot 76 after the computer system 60 unlocks the panel 72 and the operator opens the panel 72.

Two side frame-sized locking pieces 9 in two side mounted automated locking devices 41 may each also be moved to the extended position 2 by the computer system 60 before unlocking the panel 72 to prevent an operator from removing garments 54 from either side frame 65 adjacent to the frontal frame 66.

Once the operator is done either dropping off or picking up a garment 54 on the assigned slot 76, the panel 72 may be locked by the computer system 60 when the operator enters a completion command or the computer system 60 can automatically close the panel 72 and lock it after a pre-determined amount of time has passed. Once the panel 72 is closed and locked, the computer system 60 may move the conveyor 50 to return the assigned slot 76 to its original position or any other desired location along the path 58 of the conveyor 50.

The present invention provides a locking apparatus for restricting access to articles 52 on a conveyor 50, such as hooked members 53 supporting garments 54 thereon. Those with skill in the art may recognize various modifications to the embodiments of the present invention described and illustrated herein. Such modifications are meant to be covered by the spirit and scope of the appended claims.

What is claimed is:

1. An apparatus for restricting access to articles on a conveyor, the apparatus comprising:
a locking piece configured to be movably mounted adjacent to a portion of the conveyor, the locking piece preventing removal of articles from the conveyor when the locking piece is moved to an extended position against the articles and the conveyor.

2. The apparatus of claim 1, wherein the locking piece further prevents insertion of articles onto the conveyor when the locking piece is moved to an extended position against the articles and the conveyor.

3. The apparatus of claim 1, wherein the locking piece enables removal of articles from the conveyor when the locking piece is moved to a retracted position away from the articles and the conveyor.

4. The apparatus of claim 2, wherein the locking piece enables insertion of articles onto the conveyor when the locking piece is moved to a retracted position away from the articles and the conveyor.

5. The apparatus of claim 1, further comprising a computer system connected to the locking piece and configured to control the movement of the locking piece.

6. The apparatus of claim 1, further comprising an actuator coupled to the locking piece and adapted to drive the locking piece to the extended position.

7. The apparatus of claim 6, wherein the actuator is adapted to return to the locking piece to a retracted position.

8. The apparatus of claim 6, further comprising an air solenoid unit connected to the actuator, the air solenoid unit activating the actuator to drive the locking piece to the extended position.

9. The apparatus of claim 6, wherein the actuator comprises a cylinder and a piston driven within the cylinder.

10. The apparatus of claim 9, wherein the locking piece is coupled to a free end of the piston.

11. The apparatus of claim 9, wherein the cylinder is a dual-acting air cylinder.

12. The apparatus of claim 9, wherein the air solenoid unit comprises a valve, the air solenoid being connected to the actuator by connecting the valve to the cylinder.

13. The apparatus of claim 12, wherein the valve comprises an intake port and an exhaust port.

14. The apparatus of claim 13, wherein opening the intake port permits air to enter the cylinder from the air solenoid unit distally moving the piston and driving the locking piece to the extended position.

15. The apparatus of claim 14, wherein opening the exhaust port releases air from the cylinder proximally moving the piston and returns the locking piece to a retracted position.

16. The apparatus of claim 15, wherein closing the intake port and the exhaust port locks the locking piece in one of the extended position and the retracted position.

17. The apparatus of claim 16, further comprising a computer system connected to the air solenoid unit, wherein the computer system is configured to control the movement of the locking piece by controlling the opening of at least one of the intake port and the exhaust port.

18. The apparatus of claim 1, wherein the articles are hooked members, each of the hooked members having a hooked portion with a free end, a neck and a body for supporting a garment thereon.

19. The apparatus of claim 1, wherein the portion of the conveyor comprises a slot.

20. The apparatus of claim 19, wherein the slot comprises an opening in the conveyor configured to receive and suspend a free end of at least one hooked member.

21. The apparatus of claim 20, wherein the at least one hooked member is suspended from the slot.

22. The apparatus of claim 1, wherein the locking piece includes a surface, and wherein the surface prevents removal of articles from the conveyor by being adapted to engage the articles with the portion of the conveyor when the locking piece is moved to an extended position against the articles and the conveyor.

23. The apparatus of claim 21, wherein the locking piece includes a surface, and wherein the surface prevents removal of articles from the conveyor by being adapted to engage the at least one hooked member with the slot when the locking piece is moved to an extended position against the articles and the conveyor.

24. The apparatus of claim 21, wherein the surface is adapted to engage the at least one hooked member with the slot by contacting a surface of the at least one hooked member and contacting a surface of the slot.

25. The apparatus of claim 1, wherein the portion of the conveyor comprises a frame.

26. The apparatus of claim 25, wherein the frame comprises a plurality of sequential slots.

27. The apparatus of claim 26, wherein the plurality of sequential slots includes five sequential slots.

28. The apparatus of claim 27, wherein each of the plurality of sequential slots comprises an opening in the conveyor configured to receive and suspend a free end of at least one hooked member.

29. The apparatus of claim 28, wherein each of the at least one hooked member is suspended from a slot in the plurality of sequential slots.

30. The apparatus of claim 29, wherein the locking piece has a surface, and wherein the surface prevents removal of articles from the conveyor by being adapted to engage the at least one hooked member with the frame when the locking piece is moved to an extended position against the articles and the conveyor.

31. The apparatus of claim 30, wherein the surface is adapted to engage the at least one hooked member with the frame by contacting a surface of the at least one hooked member and contacting a surface on each of the plurality of sequential slots.

32. An automated locking system for restricting access to hooked members, comprising:
a conveyor including a plurality of frames, each of the plurality of frames comprising a plurality of sequential slots, the conveyor configured to transport hooked members and garments suspended therefrom in the plurality of sequential slots along a path;
a first automated locking device including a first locking piece and a first actuator coupled to the first locking piece, the first locking piece movably mounted adjacent to a first frame location on the path, the first actuator adapted to drive the first locking piece, wherein the first locking piece prevents removal of hooked members from a first frame on the conveyor when the first frame is moved to the first frame location and the locking piece is moved to a first extended position against the hooked members and the first frame;
a plurality of sequentially aligned second automated locking devices each including a second respective locking piece and a second respective actuator coupled to the second respective locking piece, the second respective locking piece configured to be movably mounted adjacent to a second respective slot location in a second frame location on the path, the second respective actuator adapted to drive the second respective locking piece, wherein the second respective locking piece prevents removal of hooked members from a second respective slot in a second frame on the conveyor when the second frame is moved to the second frame location and the second respective locking piece is moved to the second respective extended position against the hooked members and the second respective slot;
a third automated locking device including a third locking piece and a third actuator coupled to the third locking piece, the third locking piece configured to be movably mounted adjacent to a third frame location on the path, the third actuator adapted to drive the third locking piece, wherein the third locking piece prevents removal of hooked members from a third frame when the third frame is moved to the third frame location and the locking piece is moved to a third extended position against the hooked members and the third frame; and
a central locking control system including an air solenoid unit connected to each of the first automated locking device, the plurality of sequentially aligned second automated locking devices and the third automated locking device, and a computer system connected to the air solenoid unit,
wherein the air solenoid unit is adapted to separately activate each of the first actuator, the second respective actuator in the plurality of sequentially aligned second automated locking devices and the third actuator, and wherein the computer system is configured to control the separate activation of each of the first actuator, the second respective actuator in the plurality of sequentially aligned second automated locking devices and the third actuator by the air solenoid unit.

33. The automated locking system of claim 32, wherein each of the respective second locking piece in the plurality of sequentially aligned second locking devices enables at least one of removal of hooked members from the second respective slot and insertion of hooked members on the second respective slot when the second locking piece is moved to a second retracted position away from the hooked members and the conveyor.

34. The automated locking system of claim 33, wherein the air solenoid unit includes a plurality of valves, each of the first automated locking device, the plurality of sequentially aligned second automated locking devices and the third automated locking device connected to the central locking control system by connecting each of the first actuator, the respective second actuator in the plurality of second automated locking devices and the third actuator with a respective valve in the plurality of valves.

35. The automated locking system of claim 34, wherein the computer system is adapted for separate activation of each of the first actuator, the second respective actuator in the plurality of sequentially aligned second automated locking devices and the third actuator by the air solenoid unit by separately controlling each of the first valve, the plurality of second valves, and the third valve.

36. The automated locking system of claim 32, wherein the first, second and third frames are sequential frames on the conveyor, and wherein the first, second and third frame locations are sequential frame locations on the path.

37. The automated locking system of claim 36, wherein the first, second and third frame locations form a U-shaped turn, an inner surface of the first automated locking device facing an inner surface of the third automated locking device.

38. The automated locking system of claim 37, wherein the computer system is configured for starting the conveyor, for moving the conveyor whereby the first, second and third frames are moved to the first, second and third frame locations, and for stopping the conveyor.

39. The automated locking system of claim 32, wherein the computer system is adapted to move at least one identified slot on the conveyor to at least one identified slot location as a function of input from an operator.

40. The automated locking system of claim 32, wherein the automated locking system is contained in a secure area.

41. The automated locking system of claim 40, wherein an operator is outside of the secure area, the operator being selectively enabled to access a portion of the conveyor at a fixed location to at least one of insert and remove at least hooked member from the conveyor.

42. The automated locking system of claim 41, wherein the fixed location comprises an article access station.

43. The automated locking system of claim 42, wherein the portion of the conveyor is the second frame when the second frame is moved to the second frame location.

44. The automated locking system of claim 42, wherein the article access station includes a selectively locking panel.

45. The automated locking system of claim 44, wherein the computer system is configured to control a locking of the selectively locking panel.

46. The automated locking system of claim 45, further comprising an operator interface connected to the computer system enabling an operator to input identification information into the computer system.

47. The automated locking system of claim 46, wherein the computer system is configured to assign at least one select slot on the conveyor to the operator and store a correlation between the at least one select slot and the identification information.

48. The automated locking system of claim 47, wherein the computer system is configured to determine a location of the at least one select slot, and move the at least one select slot to the second frame location.

49. The automated locking system of claim 48, wherein the computer system is configured to use the identification information to unlock the selectively locking panel.

50. The automated locking system of claim 49, wherein the computer system is configured to restrict access by an operator to the at least one selected slot by moving each of the second respective locking pieces corresponding to each of the at least one select slot to the second retracted position, moving remaining second respective locking pieces in the plurality of sequentially aligned second automated locking devices to the second extended position.

51. The automated locking system of claim 50, wherein the computer system is configured to secure the restricted access by moving the first and third locking pieces to the extended position against the hooked members and the conveyor.

52. A method for providing restricted access to hooked members on a conveyor, the conveyor including a plurality of slots, the method comprising the steps of:
selecting at least one slot of the plurality of slots; and
selectively moving at least one locking piece to an extended position to block access to at least one slot adjacent to the selected at least one slot.

53. The method of claim 52, wherein the step of selecting the at least one slot includes the step of selecting the at least one slot using a computer system.

54. The method of claim 52, wherein the step of selectively moving the at least one locking piece includes the step of selectively moving the at least one locking piece using a computer system.

55. The method of claim 52, further comprising the step of receiving employee identification information.

56. The method of claim 55, wherein the step of selecting the at least one slot includes the step of correlating the employee identification information with the at least one select slot.

57. The method of claim 56, further comprising the step of an operator entering the employee identification information.

58. The method of claim 57, wherein the step of the operator entering the employee identification information includes the step of the operator entering the employee identification information into an operator interface connected to a computer system.

60. The method of claim 52, wherein the step of selectively moving the at least one locking piece to the extended position includes actuating at least one piston in a cylinder to drive the at least one locking piece to the extended position.

61. The method of claim 60, wherein the step of actuating the at least one piston includes opening a valve to permit air to enter the cylinder from an air solenoid unit and drive a movement of the piston.

62. The method of claim 61, wherein the step of opening the valve includes the step of opening the valve using a computer system.

63. The method of claim 52, further comprising the step of suspending hooked members from the plurality of slots.

64. The method of claim 63, wherein the step of selectively moving the at least one locking piece to the extended position includes moving the at least one locking block against the hooked members in the at least one slot adjacent to the selected at least one slot.

65. The method of claim 52, further comprising the step of moving the conveyor along a conveyor path to move the selected at least one slot to a restricted access area, before selectively moving the at least one locking piece, the at least one locking piece being positioned adjacent to the conveyor path in the restricted access area.

66. The method of claim 52, further comprising the step of an operator accessing the selected at least one slot after the step of selectively moving the at least one locking piece, to at least one of insert and remove hooked members on the selected at least one slot.

67. The method of claim 65, further comprising the step of an operator accessing the selected at least one slot in the restricted access area after the step of selectively moving the at least one locking piece.

68. The method of claim 67, wherein the step of the operator accessing the selected at least one slot includes the step of unlocking a selectively locking panel to expose a portion of the conveyor in the restricted access area to the operator while blocking access to a remainder of the conveyor.

69. The method of claim 68, wherein the step of unlocking the selectively locking panel includes the step of unlocking the selectively locking panel using a computer system.

70. The method of claim 68, further comprising the step of receiving a completion command to indicate completion of the operator's access of the selected at least one slot.

71. The method of claim 70, further comprising the step of locking the selectively locking panel to block access to the conveyor.

72. The method of claim 68, further comprising the step of automatically closing and locking the selectively locking panel to block access to the conveyor after the passage of a pre-set amount of time from the unlocking of the selectively locking panel by using a computer system.

73. The method of claim 67, wherein a select frame includes a plurality of sequentially aligned slots including the selected at least one slot and a remainder of slots, the at least one adjacent slot including the remainder of slots in the select frame.

74. The method of claim 73, further comprising the step of moving a plurality of frame-sized locking pieces to a frame extended position to block access to at least one frame adjacent to the select frame, each of the at least one frame including a plurality of sequentially aligned slots.

75. The method of claim 74, wherein the step of moving the frame-sized locking pieces includes the step of moving the frame-sized locking pieces using a computer system.
